(19) United States
(12) Patent Application Publication
(10) Pub. No.: US 2007/0073740 A1
(43) Pub. Date: Mar. 29, 2007

(54) Retrieving a value associated with a property based on a hierarchy of components

(76) Inventor: Evan R. Kirshenbaum, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/239,918

(22) Filed: Sep. 29, 2005

(51) Int. Cl. G06F 17/00

(52) U.S. Cl. 707/100

(57) ABSTRACT

A data structure associates components in a hierarchy with corresponding maps that associate values with respective properties. In response to a request to retrieve a value associated with a first property for a first component that is part of the hierarchy, the data structure is accessed in an order defined by the hierarchy to retrieve the value associated with the first property.

### BACKGROUND

In many software systems, objects (which can be associated with software programs) are associated with values, which can be defined as the values of properties. It is often desirable to be able to assert that some or all objects of a certain type (e.g., objects of a particular class) are to have the same values for a given property. However, conventional mechanisms do not provide efficient mechanisms of assigning values to properties of various objects, particularly when such objects are of types in a system that are interrelated in a hierarchy (e.g., a hierarchy of classes).

In addition, objects are also often associated with metadata (also referred to annotations). The annotations of these objects are typically in the form of a value associated within the object with a key (or name). A benefit of using annotations for objects is that different pieces of software written by different programmers at different times can decide what named data values are associated with objects, and these named data values are accessible much as though such data values had been declared to be part of the objects themselves by the programmers who wrote the declarations of the types of the objects. Thus, one software component may be associated with the declaration of a type of an object, while another software component (potentially written after the first software component or by a different entity) can associate some type of an annotation with the object (for example, the annotation can be a label annotation used for display in a graphical user interface). The flexibility of being able to add annotations to objects allows for more flexible use of objects among software components developed at different times.

When it is desired to store, display, or communicate an object containing annotations, a decision is made as to which annotations should be stored, displayed, or communicated along with the object. However, conventional mechanisms do not enable efficient handling of asserting policies for such storing, display, or communication of annotations, especially when the declaration of the annotation and the specification of the policy are to be made by different pieces of software possibly written by different programmers at different times.

### BRIEF DESCRIPTION OF THE DRAWINGS

Some embodiments of the invention are described with respect to the following figures:

FIG. 1 is a block diagram of an example computer that incorporates an embodiment of the invention;

FIG. 2 illustrates an example hierarchy of classes that can be processed by some embodiments of the invention;

FIG. 3 illustrates a “threshold” class property table object that maps various example threshold values to respective properties for corresponding classes, according to an example embodiment;

FIG. 4 is a flow diagram of a process for looking up a value of a property, according to an embodiment;

FIGS. 5-7 illustrate different example states of the threshold class property object of FIG. 3, in accordance with an example embodiment;

FIG. 8 illustrates an annotatable object and a persistence policy object, according to another embodiment; and

FIG. 9 is a flow diagram of a process for determining whether an annotation associated with an object should be persistent.

### DETAILED DESCRIPTION

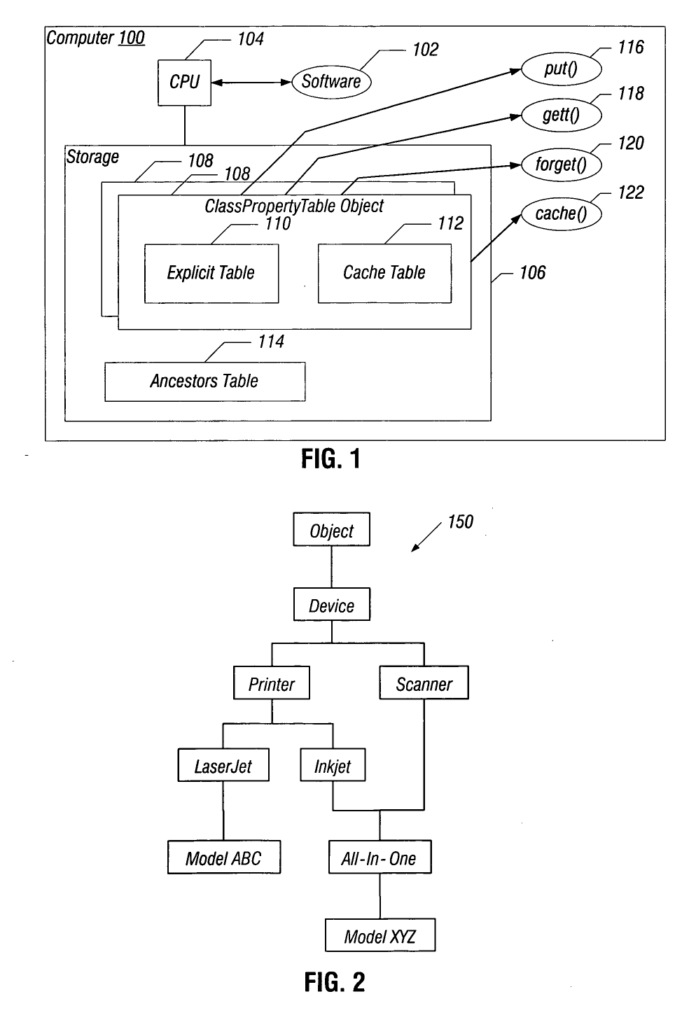

FIG. 1 illustrates an example computer 100 that contains software 102 executable on one or more central processing units (CPUs) 104. The one or more CPUs 104 are connected to a storage 106, which stores various instances of a class referred to as ClassPropertyTable. Each instance of ClassPropertyTable is also referred to as a ClassPropertyTable object 108. In general, an object is an instance of a class of the object (which is often just called a “class” or “type”). A class of objects can be viewed as a template from which many objects can be formed.

In accordance with some embodiments of the invention, the ClassPropertyTable object 108 is associated with three tables, including an explicit table 110, a cache table 112, and an ancestors table 114. The explicit table 110 is used to associate various classes of a class hierarchy to corresponding maps, where each map associates property names (equivalently “properties” or “names”) with respective property values. In the explicit table 110, the classes are considered “keys” that are associated with respective maps that perform assignment of values to properties. More generally, a “property name” or “property” is a name or other type of label that can be associated with various values (or other information). A property name and the data value (or other information) associated with the property name can be associated with a class or, equivalently, objects which are instances of a class. The explicit table 110 is more generally a data structure for associating classes with respective maps that associate data values (or other information) with property names. More generally, a ClassPropertyTable object 108 can be considered a property table object that associates information with property names.

A “class hierarchy” refers to a hierarchy of classes that are inter-related by inheritance among the classes (a first class inherits from a second class, a third class and fourth class both inherit from the first class, and so forth). A class that inherits from a second class inherits features of the second class, with the first class adding further details.

Although reference is made to associating maps with classes in the explicit table 110, it is noted that other embodiments can be further generalized by associating maps with “components” in the explicit table 110, where components can be any one of a class, object, or any other representation of a thing.

In one example embodiment, the properties and their associated values are threshold values used for event reporting. For example, the computer 100 can be part of the system that monitors devices (such as printers, scanners, and so forth). The devices that are being monitored can periodically report the state of various characteristics of the devices, such as the level of consumables (e.g., paper left, toner level, ink level), the amount of idle time, and so forth. Each such characteristic which might warrant an alert being sent to a user is associated with a property name. The values associated with the properties (for a given object or a class of a given object) are used to specify thresholds at which alerts are sent to a user. For example if the amount of paper left in the printer is less than some predetermined number of pages, then a low paper alert can be issued. Similarly, alerts regarding low toner or ink conditions, excessive idle conditions, and so forth, can also be issued based on the threshold values.

The cache table 112 associates properties with mappings from classes to respective values based on the results of prior queries making use of the mappings provided by the explicit table 110. The cache table 112 behaves similar to any cache in that the cache table 112 allows faster lookup of the values associated with properties for particular classes when this value is known to not have changed since a similar prior query.

The ancestors table 114 associates with classes an ordered sequence of a class's respective superclasses (the ancestors of the class) in a hierarchy of classes. A class may, in some programming models, be known as a “type”, “package”, or “interface”, and superclasses may be known as a “parent class (type, etc.)”. As described further below, the ancestors table 114 is used to make more efficient the use of the explicit table 110 to identify the value associated with a property in the context of a particular class. The ancestors table 114 can be shared by multiple ClassPropertyTable objects 108.

As the primary use of the cache table 112 and ancestors table 14 is to improve efficiency, some embodiments may choose to omit one or both.

Although the explicit table 10, cache table 12, and ancestors table 14 are depicted as being stored in one storage 106, it is noted that the storage 106 can actually represent multiple storage devices, such as a database, persistent disk storage, main memory, and cache memory. The explicit table 110 and ancestors table 14 can be stored in the persistent storage, while the cache table 14 is stored in a faster storage device such as the main memory or the cache memory.

Each ClassPropertyTable object 108 is associated with various software methods (which are basically software routines). These software methods include a put( ) method 116 (for updating the explicit table 110); a get( ) method 118 (for retrieving content from the explicit table 110); a forget( ) method (for removing property associations from the explicit table 110); and a cache( ) method 122 (for updating the cache table 112). Other software methods are also associated with the ClassPropertyTable objects 108, which are discussed further below.

Software 102 in the computer 100 is able to access a ClassPropertyTable object 108 for the purpose of setting thresholds for various characteristics of monitored devices, as well as to retrieve thresholds when determining whether an alert is to be issued. Although depicted as one item, the software 102 can actually include multiple software modules.

In one example arrangement, the computer 100 can be a server that is coupled over a network to many devices that are being monitored. In one example, the monitored devices include printers, scanners, multi-function (or all-in-one) units, and so forth. The software 102 executable in the computer 100 includes monitoring capabilities for receiving data from the monitored devices indicating changes to monitored characteristics of the devices (such as pages left, ink level, toner level, idle time, and so forth). Based on notification of changes, the software 102 accesses a ClassPropertyTable object 108 to determine a corresponding threshold. Based on the retrieved threshold, the software 102 is able to decide whether an alert is to be issued.

FIG. 2 shows an example class hierarchy 150 that includes various classes. In the example shown, the Object class is the highest level class, with the Device class being a subclass of the Object class. Subclasses of the Device class include Printer and Scanner classes. Subclasses of the Printer class include a LaserJet class, and an InkJet class. A Model ABC class is a subclass of the LaserJet class, while an All-In-One class is a subclass of the InkJet class and the Scanner class. A Model XYZ class is a subclass of the All-In-One class. In the example hierarchy of FIG. 2, the Model ABC class represents laser printers according to a specific model (the ABC model). The Model XYZ class represents multi-function printer/scanner/fax/copier units according to a specific model (the XYZ model). Note that there could be numerous other classes in the class hierarchy 150 that are not depicted in FIG. 2.

The class hierarchy 150 indicates that printers and scanners are a type of device, laser jet printers and ink jet printers are a type of printer, and the Model ABC printer is a type of laser jet printer. Also, a multi-function unit (all-in-one unit) is both a type of ink jet printer and a type of scanner, and the Model XYZ multi-function unit is a type of all-in-one unit. Typically, an instance of one of these classes will in fact be an instance of one of the lowest-level classes, e.g., a Model ABC or Model XYZ, although in some embodiments there may be multiple levels of instantiable class, e.g., “Model ABC” and (below it) “Model ABC with duplex unit”.

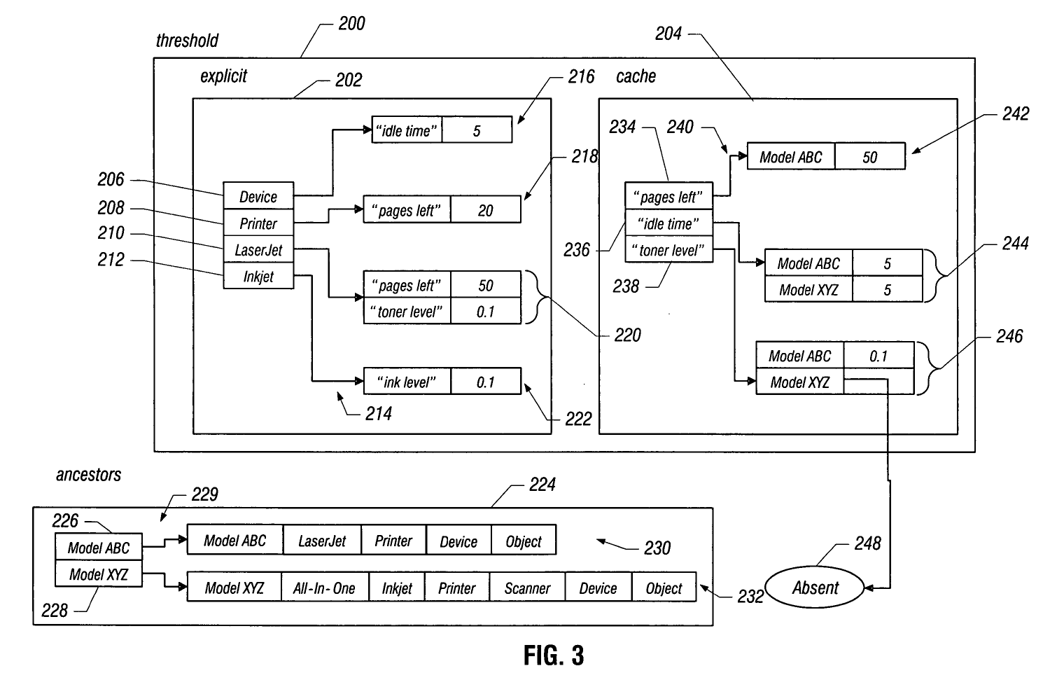

Properties can be associated with objects of the various classes in the class hierarchy 150. The associations are in the form of property names associated with values (defined by the explicit table 110 of FIG. 1). The same property name can be associated with different values for instances of different classes. In this discussion, reference to property names being “associated with a class” is equivalent to reference to property names being “associated with instances of a class”. As depicted in FIG. 3, a threshold object 200 (which is an instance of ClassPropertyTable), includes an explicit table 202 and a cache table 204 (corresponding to the explicit table 110 and cache table 14 of FIG. 1). The explicit table 202 includes, as keys, objects 206, 208, 210, 212 representing classes in the class hierarchy 150 of FIG. 2. The object 206 represents the Device class, the object 208 represents the Printer class, the object 210 represents the LaserJet class, and the object 212 represents the InkJet class. The explicit table 202 associates (at 214) the class objects 206, 208, 210, 212 with respective maps 216, 218, 220, 222. In the explicit table 202, there are two types of maps. A first type of map (such as maps 216, 218, 220, and 222) associates specific data values with respective property names. A second type of map associates the first type of map with respective class objects (such as the association between device object 206 and map 216).

In the example of FIG. 3, the map 216 associates an “idle time” property with a threshold value 5; the map 218 associates a “pages left” property with a threshold value 20; the map 220 associates a “pages left” property with a threshold value 50, and a “toner level” property with a threshold value 0.1; and the map 222 associates an “ink level” property with a threshold value 0.1. In the example depicted in FIG. 3, the “pages left” property is associated with both the LaserJet class and with the Printer class. For the Printer class, the “pages left” property is associated with a threshold value 20, whereas for the LaserJet class, the “pages left” property is associated with a different threshold value 50.

Although the property names are depicted as being strings in the example, the property names in other embodiments can be objects of any type, and in some embodiments the same ClassPropertyTable object 108 (e.g., threshold object 200) can be used to simultaneously associate values with keys of different types. In particular, the properties may be large distinct numbers (known as “globally unique identifiers” (“GUIDs”), “universally unique identifiers” (“UUIDs”), or simply “unique identifiers” (“UIDs”)) or they may be complex objects which contain references to their associated class property tables and which provide methods for accessing property values for classes and/or objects by delegation to their respective property tables. If a property is an object, then a request to retrieve a value associated with the property would be issued to the object, with the object using its associated ClassPropertyTable object to retrieve the value of the property in response to the request. Note that multiple such property objects may share the same ClassPropertyTable object.

The different threshold values associated with the “pages left” property for the LaserJet class and the Printer class are conflicting. In accordance with some embodiments, the software methods associated with a ClassPropertyTable object 108 enables the retrieval of the correct value for the property despite the potentially conflicting assignment of different values to the same property for different classes based on the class hierarchy 150. For example, if a Model ABC laser printer has experienced a change in the number of pages, the software 102 in the computer 100 can detect this change, and can determine which of the threshold values to use to determine whether an alert should be issued to a user. The correct threshold value for the “pages left” property is selected by accessing the explicit table 202 in an order reflecting the hierarchical structure of the class hierarchy 150.

The relationships of the Model ABC class and the Model XYZ class to other classes in the hierarchy 150 of FIG. 2 are summarized in an ancestors table 224 (corresponding to the ancestors table 14 of FIG. 1). In a first sorted list 230, the ancestors table 224 specifies that the Model ABC class 226 is associated (at 229) with the following classes: Model ABC, LaserJet, Printer, Device, and Object, in ascending order in the class hierarchy 150. Similarly, in a second sorted list 232, the Model XYZ class 228 is associated (229) with the following classes in ascending order: Model XYZ, All-In-One, InkJet, Printer, Scanner, Device, and Object. Generally, each sorted list in the ancestors table 14 is sorted such that a first ancestor component in the list that is an ancestor of a second ancestor component in the list does not precede the second ancestor component in the list. For example, the sorted list 230 is sorted such that the Printer class, which is an ancestor of the LaserJet class, does not precede the LaserJet class in the list 230. To build up each sorted list, the parents of each ancestor component in the list is identified by querying a predetermined entity, such as a runtime system, for the list of parents of each ancestor component. The identification of parents of each ancestor component is performed recursively to build up the list.

In response to notification of the pages left of a Model ABC printer, the software 102 invokes the get( ) method 118 (FIG. 1) associated with the threshold ClassPropertyTable object 200 to access the explicit table 202 (assuming the cache table 204 does not contain the corresponding entry) in the order specified by the sorted list 230 for the Model ABC class 226 to determine which threshold value to use for the “pages left” property. The parameters supplied to the get( ) method 118 include an object representing a class (in this case the Model ABC class object 226) or an object whose class will be used as well as the property in question (in this case the “pages left” property).

In the example depicted in FIG. 3, the get( ) routine 118 first checks for the presence of an object representing the Model ABC class as a key in the explicit table 202. Not finding such a Model ABC class object in the explicit table 202, the get( ) method 118 then goes up the hierarchy (according to the order specified by the sorted list 230 associated by the ancestors table 224 with the Model ABC class) to the LaserJet class object 210 and finds that there is in fact an associated map 220, which associates a value with the “pages left” property. Thus, the value associated with the “pages left” property for the LaserJet class object 210 is retrieved (the threshold value 50) for determining whether the change in pages left at the Model ABC printer should cause generation of an alert. Note that the value associated with the “pages left” property in the map 220 (for LaserJet class) is used instead of the value associated with the “pages left” property in the map 218 (for the higher level Printer class). Effectively, the map 220 associating a value with the “pages left” property takes precedence over the association of a different value with the “pages left” property in the map 218, based on the fact that the LaserJet class is at a lower level in the class hierarchy 150 than the Printer class and therefore comes first in the sorted list 230. In other words, the explicit association of a value with the “pages left” property for the LaserJet class overrides the association of a value with the same property in a superclass (either an immediate parent class or a further ancestral class) of the LaserJet class. This ability to override assignments of superclasses provides enhanced flexibility for users in setting and using thresholds.

By associating a value with a given property for a higher level class in the hierarchy 150, a convenient mechanism is provided to assert that some or all objects of a certain type (e.g., objects of a particular class) are to have the same value for the given property. For example, a specific value for the “pages left” property can be associated with the Printer class such that various different types of printers can use this “pages left” property value. Effectively, when types (e.g., classes) are interrelated in a hierarchy (such as class hierarchy 150), the hierarchical structure can be used to infer the value of a property even when none has been specified for the particular type of an object.

However, according to some embodiments, this general association of property values with a higher level class is overridable in that an association of a value with a property at a lower level class (e.g., LaserJet class) can be made to override the general association of the value with the property at a higher level class.

To enhance performance, the cache table 204 stores certain values for several properties associated with values in the explicit table 202 to enable retrieval of property values from the cache table 204 and avoid performing computations associated with accesses of the explicit table 202 each time. The cache table 204 stores property values that have been accessed previously from the explicit table 202 and which are known to still be the values associated with their respective property names for their respective classes. In the example shown in FIG. 3, three property names (“pages left” 234, “idle time” 236, “toner level” 238) are associated (at 240) with respective maps 242, 244, and 246. Note that the cache table 204 has a format that differs from the explicit table 202. Unlike the explicit table 202, the cache table 204 associates property names with maps that associate classes with values previously determined by the get( ) routine to be associated with those property names for those classes. Thus, the map 242 (associated with the “pages left” property 234) associates the Model ABC class with the threshold value 50. What this means is that the threshold value 50 should be used for the “pages left” threshold property 234 for the Model ABC class. Although the Model ABC class is actually not contained as an explicit key in the explicit table 202, the threshold value of 50 has been determined earlier (during a retrieval process) to be the correct value to use for the “pages left” property. Note that in the previous retrieval of the value of the “pages left” property for Model ABC, the threshold value 50 was retrieved based on association of the threshold value 50 with the “pages left” property associated with the LaserJet class 210 in the explicit table 202.

By associating properties with maps in the cache table, software can quickly determine whether a particular value has been assigned to a property and the software can also quickly remove such cached entries when they are no longer known to be valid.

The map 244 in the cache table 204 associates threshold values with the Model ABC class and the Model XYZ class that are associated with the “idle time”property 236. Similarly, the map 246 associates the threshold value with the Model ABC class for the “toner level” property. The map 246 also associates a Absent singleton object 248 with Model XYZ to represent the fact that there is known to be no information about the “toner level” property for the Model XYZ class in the explicit table 202. A singleton object is an object for which there is a single unique instance. In this embodiment, a single shared Absent object is referred to as the value in such tables when a class is known to not have a value for a property. In other embodiments, distinct objects could be so used or the table itself may record this status without reference to an object.

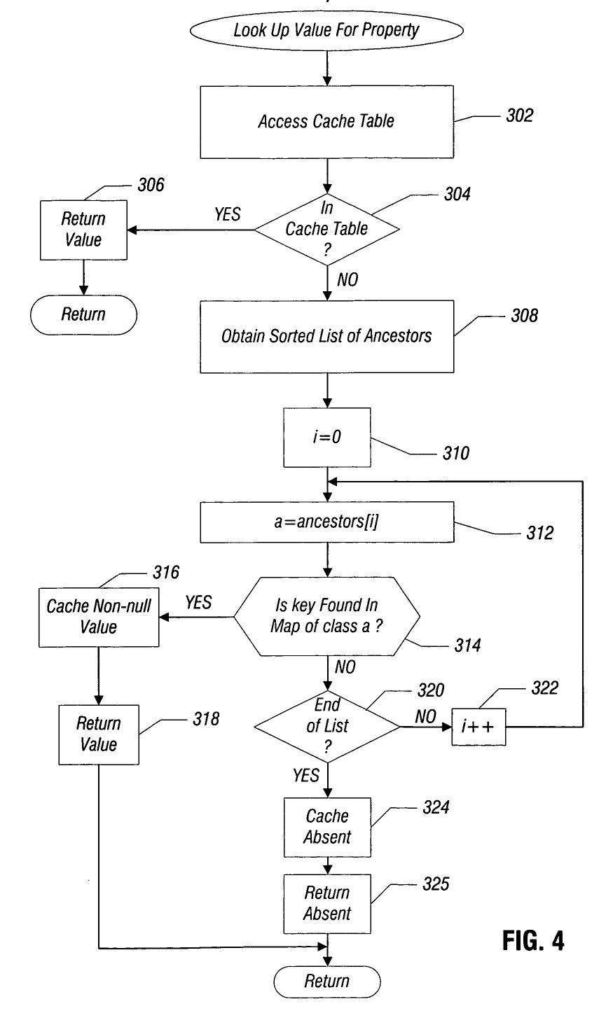

FIG. 4 illustrates a flow diagram for looking up a value for a specific property associated with a certain class. It is invoked by calling the get( ) method, which in accordance with one example embodiment, is defined below. The get( ) method is a request to retrieve a value for a specified property that is associated with a specified class. In some embodiments, the get( ) method is invoked in response to another prior request that is submitted to retrieve a value for the specified property associated with an instance (or object) of the specified class.

```
Object get(Class c, String property) {
  Object val = compute(c, property);
  return val == NULL ? null : val == ABSENT ? null : val;
}
```

The parameters passed to the get( ) method include the class “c” and a string “property.” In one example implementation, the get( ) method delegates to a compute( ) method, which is defined further below. The example definition for the get( ) method is in Java code. Note that in other implementations, other software languages can be used for defining the get( ) method. The get( ) method presented above can return an object of any type which inherits from the Object class. In some embodiments, the get( ) method may be restricted to return values of a particular type, such as Boolean (true or false) values, numbers, strings, or instances of a particular class. This may be accomplished by modifying the get( ) method or providing other methods which delegate to the get( ) method. Such other methods may be provided by the ClassTableProperty objects or by other objects that refer to the ClassTableProperty objects.

According to the Java programming language, a Map object is an instance of a class that associates keys with values. For example, the association of keys with respective values in the explicit table 200 is implemented with Map objects, according to one example. The Map object will return a null value (a value that does not refer to any actual object) from a query both when there is no value associated with the given key and when the value associated with the given key is null. The compute( ) method distinguishes these two situations, returning a reference to a distinguished “ABSENT” object in the first case and a distinguished “NULL” object (different from a normal null reference) in the second. When the get( ) method receives either of these values from the compute( ) method, it returns a null value to its caller. Such a technique is known as masking the null, and the distinguished “NULL” object is known as a mask value. In some embodiments a ClassPropertyTable object 106 may further provide a has Value( ) method which allows a user to distinguish these two cases by querying whether a value is associated with a property for a particular class. In other embodiments, the get( ) method may return distinct values in the two cases. In some embodiments, the get( ) method may return a value other than null (e.g. zero or the empty string) when compute( ) returns the ABSENT object.

The compute( ) method looks up the value (threshold value) for the specified property (the “property” string) for a particular class (“c”). As shown in FIG. 4, the compute( ) method first accesses (at 302) the cache table 204 to determine if the cache table 204 contains an entry whose key is the specified property and whose associated value has an entry whose key is the particular class object. If this is the case, the get( ) method returns as its value the value associated with the class object in the table (e.g., 242, 244, 246) associated with the property.

If the desired property value cannot be found in the cache table 204, then the compute( ) method obtains (at 308) the sorted list of ancestors for the specified class. If the ancestors table 224 contains an entry whose key is the specified class, the value associated with this key is used. Otherwise, a sorted list of the ancestors of the specified class is constructed using mechanisms provided by the programming language and environment used. In the Java programming language, the list can be sorted based on the criteria that one class should follow another in the resulting list if the first would answer “true” to a query of its isAssignableFrom( ) method with the other as a parameter. In the example shown in FIG. 3, if the specified class were the Model ABC class, the sorted list of ancestors would be sorted list 230. The compute( ) method walks through this sorted list (in the order defined by the class hierarchy 150 (FIG. 2)) to find the threshold value for the lowest level class in the hierarchy 150 for which an entry exists in the explicit table 202 with that class as the key and whose associated table contains an entry with the given property as the key. For example, as discussed above in connection with FIG. 3, if the Model ABC class had been specified as “c” and the “pages left” property is specified as “property” in the call to the get( ) method that resulted in this call to the compute( ) method, such a lowest level class would be the LaserJet class (rather than the Printer class) for which threshold values have been associated with the “pages left” property.

To walk through the sorted list, a parameter i is set to an initial value zero (at 310), followed by setting a parameter a to ancestors[i] (ancestors[0] refers to the first object (the lowest level class object) in the sorted list (such as the Model ABC object in the sorted list 230)).

The compute( ) method next determines (at 314) if the specified property can be found in the map associated with class a (if such a map exists). If so, then the property value is cached (at 316) in the cache table 204 for the specified class (e.g., Model ABC or Model XYZ) and returned (at 318). However, if there is no entry for class a in the explicit table 202 or if there is no entry for the property in the map associated with class a, then the compute( ) method determines (at 320) if it has reached the end of the sorted list. If not, the parameter i is incremented (at 322), with the process of 312 and 314 repeated to find a map for a higher level class that associates a value with the specified property. If the end of sorted list has been reached (as determined at 320), then that is an indication that there is no map in the explicit table 202 that associates a value with the specified property for any class in the ancestry (specified by the sorted list retrieved from the ancestor table) of the specified class. In this case, a map in the cache table 204 is updated to correlate the Absent singleton object with the specified property (e.g., the correlation of the Absent singleton object 248 (FIG. 3) with the Model XYZ class in the map 246 of FIG. 3) and this Absent object is returned (at 325).

As mentioned above, the process performed in FIG. 4 is defined in the compute( ) method delegated to by the get( ) method. Example definitions of the compute( ) method are provided below. In an alternative embodiment, instead of delegating to the compute( ) method, the code can be defined as part of the get( ) method. Tasks 302, 304, and 306 of FIG. 4 are implemented with the following example Java code:

```
Map map = (Map)cache.get(property);
if (map != null) {
  Object val = map.get(c);
  if (val != null) {
    return val;
  }
}
```

Task 308 of FIG. 4 is implemented with the following Java code:
Class[ ] ancestors=getAncestors(c);

Tasks 310-324 are implemented with the following Java code:

```
for (int i = 0; i < ancestors.length; i++) {
  Class a = ancestors[i];
  Map map = (Map)explicit.get(a);
  if (map != null) {
    Object val = map.get(property);
    if (val != null) {
      cache(c, property, val);
      return val;
    }
  }
}
cache(c, property, ABSENT);
return ABSENT;
```

The cache( ) method invoked above is defined according to the following example Java code:

```
void cache(Class c, String property, Object val) {
  Map map = (Map)cache.get(property);
  if (map == null) {
    map = new HashMap( );
    cache.put(property, map);
  }
  map.put(c, val);
}
```

The cache( ) method is called to cache a non-null value (at 318) or to cache an Absent singleton object (at 324) in FIG. 4. In the code for the cache( ) method above, a call is made to the cache get(property) routine to determine if there is already a table associated with the property in the cache table (such as cache table 204 in FIG. 3). If the cache table does not contain an entry with this property as its key, then a new map is created (new HashMap). Although reference is made to HashMap, it is noted that other types of maps or tables can be defined in other implementations. After creation of the new map, the cache.put(property, map) routine is called to associate the key with the associated map (such as property value 234 and associated map 242 in FIG. 3) in the cache table 204. Then the map.put(c,val) routine is called to associate the value with the class in the map (such as any of maps 242, 244, 246 in FIG. 3), whether preexisting or newly created.

In addition to the example get( ) method defined above, the put( ) method (shown as element 116 in FIG. 1) can be defined for ClassPropertyTable objects 106 according to the following implementation:

```
void put(Class c, String property, Object val) {
  Map map = (Map)explicit.get(c);
  if (map == null) {
    map = new HashMap( );
    explicit.put(c, map);
  }
  map.put(key, val == null ? NULL : val);
  cache.remove(property);
}
```

The put( ) method is called to associate a value (“val”) with a property (“property”) for a corresponding class (“c”). The explicit.get(c) routine is called in the above code to determine if a map (e.g., 216, 218, 220, or 222 in FIG. 3) is associated with the class “c” in the explicit table 202. If no map is associated with this class “c,” then a new map is created and associated with the class “c” in the explicit table 202 by calling explicit.put(c, map). Then this map (whether preexisting or newly created) is modified by associating the value with the property, overwriting any previous value associated with the property. If the associated value is intended to be null, a special distinguished (non-null) object (“NULL”) is inserted instead. When the value of this property for this class is retrieved by the get( ) method, the compute method will return this as a non-null value and the get( ) method will convert it back into a true null value.

Also, the cache.remove(property) routine is called to remove the association of a table with the property from the cache table 204, ensuring that users (software in the system) of the cache table 204 will not find a value for the property for any class. This is done because, due to the modification of the explicit table 202, the cache table 204 may no longer contain valid values for the specified property (“property”). In some embodiments the put method may attempt to determine which, if any, values in the table associated with the property in the cache table 204 have been invalidated by the current modifications, but in general it is sufficient to make the conservative assumption that all might have been and that therefore all should be removed.

While the put( ) method has been described above as allowing the association of any value with any property, in some embodiments the interface may be restricted to only allow values of a certain type, such as Boolean (“true” or “false”) values, numbers, strings, values from an enumerated list, or instances of a particular class. In some embodiments this may be accomplished by modifying the put( ) method, while in other embodiments further methods may be called which “wrap” (delegate to) the put( ) method. These further methods may be provided by the ClassPropertyTable object or on other objects which refer to it.

The forget( ) method (120 in FIG. 1) is called to remove the association of any value with a specified property (“property”) for a specified class (“c”). The forget( ) method is called when software in the computer 100 no longer wishes to specify a value for the property for a particular class and desires instead that it be considered to have a value determined by the values associated with the property for its superclasses as though no prior call to put( ) had been made. An example forget( ) method is defined below:

```
void forget(Class c, String property) {
  Map map = (Map)explicit.get(c);
  if (map != null) {
    map.remove(property);
    cache.remove(property);
  }
```

In the above code, the explicit.get(c) routine is called to determine if a map is associated for the class “c.” If so, then the map.remove(property) routine is called to remove the property entry from the map in the explicit table 202, and the cache.remove(property) routine is called to remove the corresponding entry from the cache table 204.

Referring back to FIG. 3, in the cache table 204, note that the “pages left” property 234 is associated with a map 242 that contains an entry for Model ABC, but no entry for Model XYZ. What this means is that there has not been an access of the “pages left” key for the class Model ABC (and therefore, an entry has not been created in the cache table 204) since the last time a value was associated (by means of the put( ) method 116) with any class.

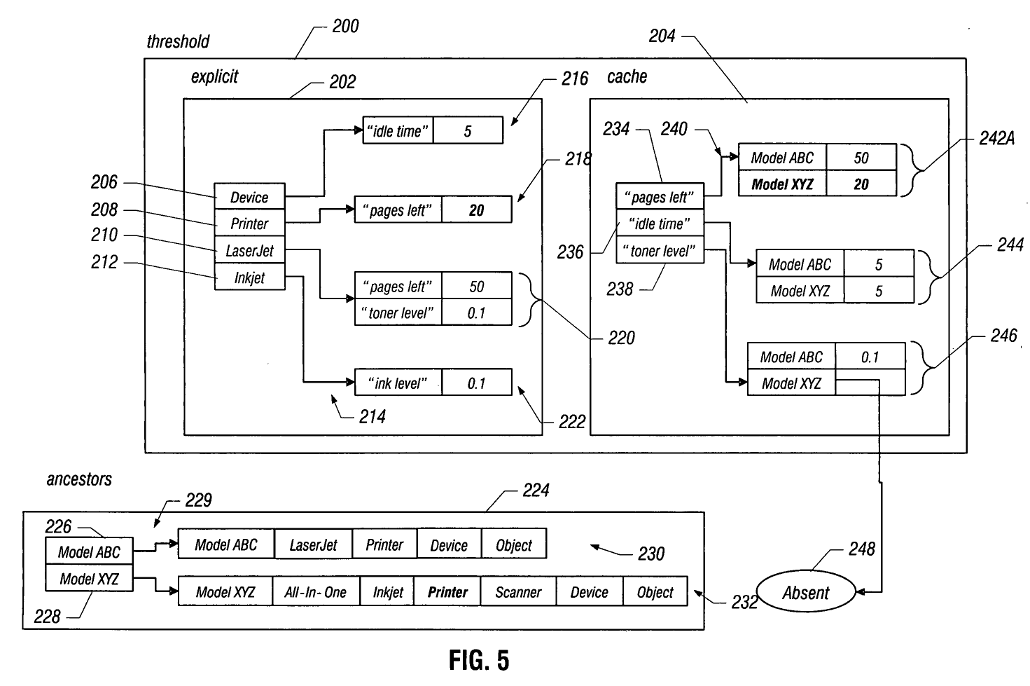

Starting from the state in FIG. 3, assume that a request has been issued by the software 102 (FIG. 1) for the value associated with the “pages left” property for the Model XYZ class. Using the sorted list 232 associated with the Model XYZ class 228 in the ancestors table 224, the explicit table 202 is accessed in the order defined by the sorted list 232 to find the lowest level class for which there is a map assigning the value to the “pages left” property (in this example, the Printer class). As a result, the value associated with the “pages left” property in the map 218 (i.e., 20) is returned to the requesting software. Further, the map 242 in the cache table 204 of FIG. 3 is updated to insert a new entry for the Model XYZ class (see updated map 242A in FIG. 5). In the map 242A of FIG. 5, the value 20 (which is the assigned value in the map 218 of explicit table 202) is correlated to the Model XYZ class.

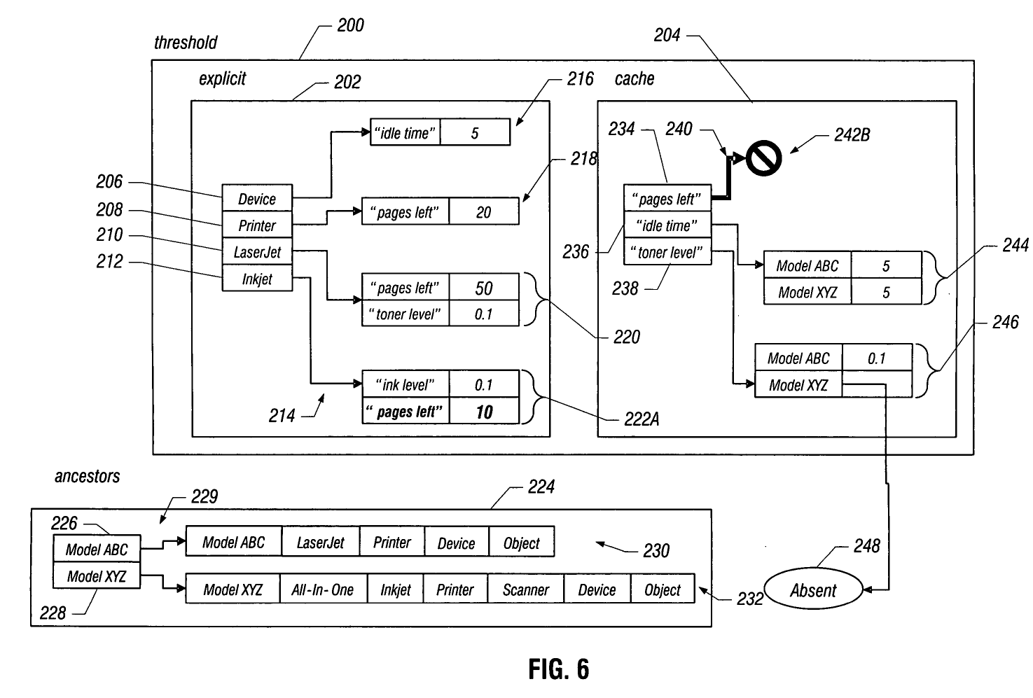

Next, it is assumed that the put( ) method (116 in FIG. 1) has been called to associate a threshold value of 10 with the “pages left” property for the InkJet class. Note that previously no explicit assignment of the “pages left” key was made for the InkJet class. As a result, the map 222 of FIG. 5 is updated to add a new entry for the “pages left” property, as depicted in FIG. 6 in the updated map 222A. In response to the update of the “pages left” property in the explicit table 202, the entry in the cache table 204 corresponding to the “pages left” property 234 is removed (since the entries in the map 242A (FIG. 5) for the “pages left” property 234 may longer be valid). In FIG. 6, the “pages left” property 234 in the cache table 204 now points to a null value 242B.

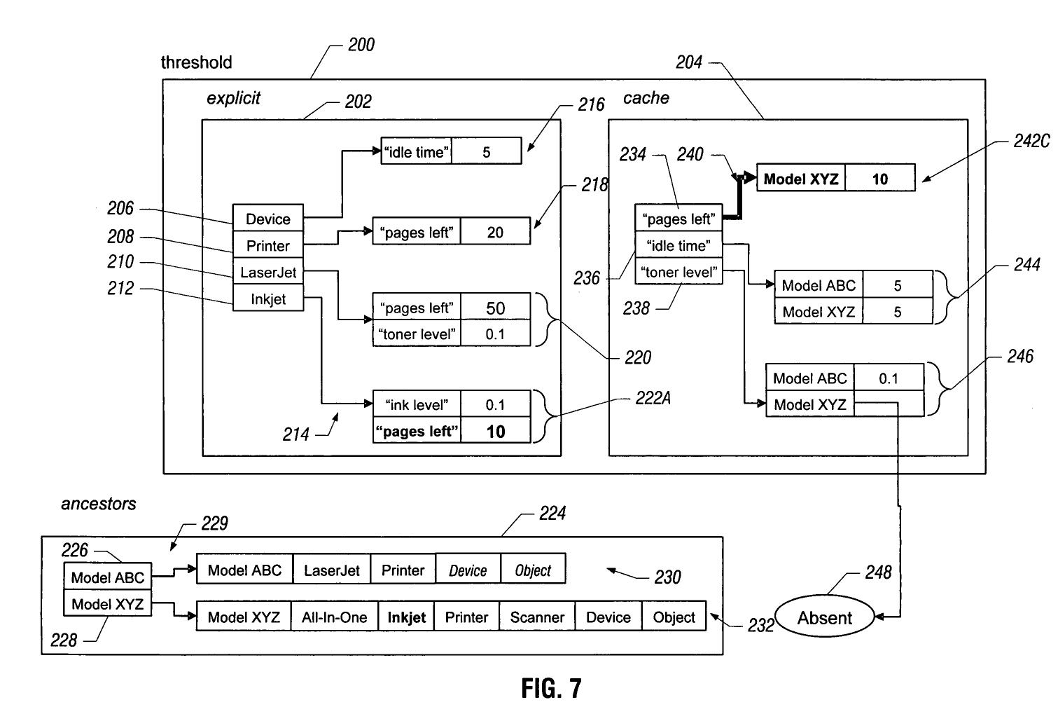

Next, it is assumed that the software 102 in FIG. 1 has issued a request to retrieve a value for the “pages left” property for a Model XYZ device. Using the sorted list 232 of the ancestors table that corresponds to the Model XYZ class 228, it is determined that the lowest level class in the explicit table 202 that is associated with a map that assigns a value to the “pages left” property is the InkJet class. In this case, the map 222A of FIG. 6 is accessed to retrieve the threshold value for the “pages left” property to return as the threshold for the Model XYZ printer. Further, the entry in the cache table 204 corresponding to the “pages left” key 234 is updated to insert a map 242C (see FIG. 7) that correlates the threshold value 10 to the Model XYZ class.

The above has described example embodiments for enabling events reporting based on thresholds assigned to classes of monitored devices within a class hierarchy using ClassPropertyTable objects (108 in FIG. 1). Different values can be associated with the same property for different classes within a class hierarchy. To ensure that correct values are returned in response to access requests for values of a specific property, the explicit table associating classes to respective maps is accessed in the order reflected by the class hierarchy such that the value for the lowest level class in the class hierarchy for which a map exists that associates a value with the specified property is retrieved. In this manner, despite potentially conflicting values assigned to the same property for different classes, an accurate property value is returned.

Another embodiment allows for indicating whether annotations (also referred to as metadata) associated with a particular object are to be considered persistent, also using a ClassPropertyTable object as well as using an AnnotatableObject interface (described further below). An annotation of a particular object can be in the form of a value associated with the particular object by means of a key (or name). Note that according to some embodiments of the invention, a property is an entity whose value is generally shared by all members of a particular class, while an annotation is a named value whose value is typically associated with specific objects. A property is a more general term in that an annotation can be considered a form of property that can be associated with an object. A persistent annotation is one for which the system ensures that the values are preserved in persistent storage so that a subsequent run of software can have access to the persistent annotations from the current run. In general, not all annotations need to be or even can meaningfully be persistent, as many have values which are only useful or meaningful within the run in which they are set. Non-persistent (or transient) annotations are simply deleted after each run of software.

Conventionally, the programmer that writes the code for a class can decide ahead of time which annotations are to be persistent. However, this approach reduces flexibility since other programmers may not be able to modify which annotations are to persist and which are not to persist. Another conventional approach involves the use of a special convention in naming the attribute (e.g., a prefix such as “persistent:”) to determine whether a particular annotation is to be persistent (e.g., “persistent:key” will indicate that any annotation containing the identified key is to be persistent). Declaration of this attribute within code may allow the writer of the code that created the annotation full control of whether the annotation is to be persistent—however, other programmers that desire to change the persistent nature of the annotation would have to modify the code (which may be difficult or impossible) to provide different declarations. Another conventional approach is to have a set of annotations that are to be persistent such that any programmer can add or remove keys from this set. However, what this means is that annotations containing the same key will be persistent regardless of what class the key is associated with.

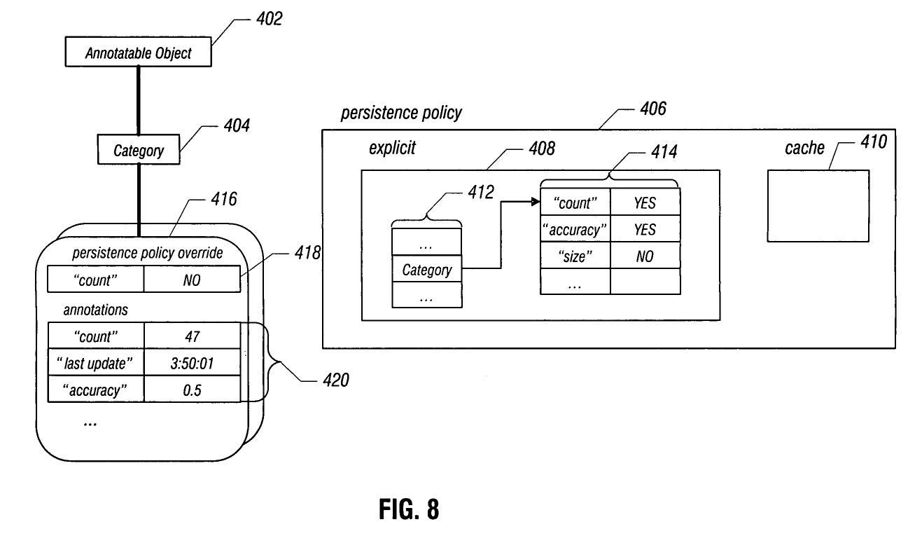

To provide flexibility for associating annotations with objects and indicating whether annotations are to be persistent according to some embodiments, an interface referred to as AnnotatableObject is defined to allow annotations to be associated with classes that inherit from the AnnotatableObject interface. The AnnotatableObject interface provides data structures to enable assigning information to annotations and to specify persistence override policies (discussed further below). FIG. 8 shows AnnotatableObject 402, and a Category class 404. The Category class 404 inherits from the interface AnnotatableObject 402. In FIG. 8, multiple Category objects 416 are depicted. Each Category object 416 includes an annotations table 420 that contains annotations (e.g., a first annotation in which the “count” key or name is assigned value 47, a second annotation in which the “last update” key is assigned a value 3:50:01, and a third annotation in which the “accuracy” key is assigned a value 0.5). In the ensuing discussion, the annotations depicted in the annotations table 420 that are part of an example Category object 416 are referred to as the “count” annotation, “last update” annotation, and “accuracy” annotation.

In addition, a persistence policy object 406 (which is an instance of ClassPropertyTable) is accessible by the Category class object 416 to determine what annotations are to be persistent. The persistence policy object 406 can be one of the ClassPropertyTable objects 108 in the storage 106 of FIG. 1. The persistence policy object 406 contains an explicit table 408 and a cache table 410 (similar to the explicit table 202 and cache table 204 in the threshold object 200 of FIG. 3). In the explicit table 408, several objects 412 representing different classes (the Category class among them) are associated with respective maps 414. Note that the Category class can also be part of a class hierarchy. For example, the class hierarchy may include many categories, including the Category class depicted in FIG. 8 along with other classes (e.g., class of cases, class of categorizers, etc.). The map 414 associated with the Category class in the explicit table 408 contains several keys, including a “count” property, an “accuracy” property, and a “size” property. Each of the properties in the map 414 is associated with a “yes” or “no” value to indicate whether the corresponding annotation is to be persistent for Category objects 416. Thus, in the example depicted in FIG. 8, the “count” annotation and the “accuracy” annotation for the Category class are to be persistent, while the “size” annotation for the Category class is not persistent (also referred to as transient). Note that according to some embodiments, this represents a particular snapshot in time. These decisions about which properties are to be considered persistent can be modified by subsequent calls to the persistence policy object's 406 put( ) and forget( ) methods.

Using the persistence policy ClassPropertyTable object 406, general declarations can be made regarding whether particular annotations are to be persistent or non-persistent for a particular class, so that some or all objects of the particular class can use the persistent/non-persistent declaration made in the persistence policy object 406. However, as explained in greater detail below, the persistent/non-persistent declarations for any particular annotation can be overridden by providing a specific declaration in the Category object 416 (enabled by the AnnotatableObject interface). The ability to override the general declarations regarding persistence or non-persistence in the persistence policy object enhances flexibility and ease of use.

In other embodiments, similar techniques (using a ClassPropertyTable object and a variation of the AnnotatableObject interface) can be used to determine whether other types of predetermined processing are to be performed with respect to annotations, including whether an annotation should be stored in a file, whether an annotation should be stored in a database, whether an annotation should be displayed, whether an annotation should be communicated as part of the object when the object is communicated from one software program to another, or whether a value assigned in an annotation should be used in computing an aggregate (e.g., a running total, a sum, an average, etc.). The decision on whether the processing is to be performed can be based on a “yes” or “no” value assigned to the respective property in an explicit table, as discussed above, or alternatively, the decision on whether processing is to be performed can be based on comparing a value retrieved from the explicit table for a particular property against the value stored for the annotation in the annotations table (e.g., 420 in FIG. 8).

More generally, a general policy can be declared for a particular annotation (or any other type of data item) in a property table regarding how the annotation is to be processed (e.g., persistently stored, displayed, communicated to another entity, or used in some predefined aggregation). This general policy regarding processing of the particular annotation can be overridden by a more specific declaration made in an instance of predefined object (e.g., Category object).

In a variation of the FIG. 8 example, instead of the Category class, the classes contained in the explicit table 408 can be the device/printer/scanner classes discussed in connection with FIGS. 5-7. Instead of assigning data values to properties representing thresholds, the FIG. 8 example assigns persistence values to properties representing persistence policies which indicate whether annotations named by the properties are persistent or non-persistent.

If the Category class is part of a class hierarchy, then the other maps associated with other classes can specify different persistence characteristics for some of the same annotations. In such a scenario, the explicit table 408 can be accessed in an order reflecting the class hierarchy to find an assigned value for the specified property. For example, if the Category class inherits from another class, and the map for the Category class does not contain an assigned value for some property, then maps for the superclasses of the Category class will be searched to determine if the property is assigned a value in those maps.

Retrieval of values and updates of values in the explicit table 408 and the cache table 410 are done in the same manner as for the explicit and cache tables of the threshold object 200 discussed above, although some implementations will ensure that the values provided to the put( ) method are restricted to the values representing YES and NO.

In addition to the assignment of persistence values to properties (annotations) in the explicit table 408 or cache table 410 of the persistence policy object 406, each Category object 416 can also be associated with a persistence policy override table 418 and an annotations table 420, both declared by the AnnotatableObject interface 402. The annotations table 420 is used to keep track of the actual values for annotations and the persistence policy override table 418 is provided to override the persistence value assigned to a particular annotation in the explicit table 408 of the persistence policy object 406. Note that the explicit table 408 applies to the Category class in general, whereas the persistence policy override table 418 applies just to the particular instance of the Category class. In some embodiments the annotations table 420 and the persistence policy override table 418 may be the same table object, with the keys (e.g., “count,” “last update,” “accuracy” in FIG. 8) to be considered to belong to the persistence policy override table 418 being distinguishable in some way from the other keys. In some embodiments, some or all annotation values may be computed rather than being stored in the annotations table 420. Such computation may make use of ClassPropertyTable objects defined according to some embodiments.

In the example of FIG. 8, the persistence policy override table 418 contains a “no” value for the “count” key, which overrides the “yes” value for the “count” property in the explicit table 408. The ability to override assignments of values to properties made in the explicit table 408 for a particular class allows for greater flexibility, since different objects of a class can have different persistence values for various annotations. For example, a first Category class object can use the “yes” value of the “count” property assigned in the explicit table 408 (such that the “count” annotation is persistent for this first Category class object). On the other hand, a second Category class object can be associated with the persistence policy override table 418 that overrides the “yes” value of the “count” property in the persistence policy table 406 by associating the “count” key with a “no” value. As a result, the “count” annotation is not persistent (or transient) for this second Category class object.

Note that while this persistence policy override table 418 is presented in conjunction with the persistence policy object 406, objects may contain similar override tables in conjunction with other ClassPropertyTable objects 108 (FIG. 1). For instance, in the examples of FIGS. 2-7, an instance of the Device class could have a threshold override table which allows specification that, even though the instance of the Device class was an instance of Model ABC, its “pages left” threshold should be a different value than the value assigned in the explicit table 202 of the threshold object 200. If the system contains multiple ClassPropertyTable objects, the multiple ClassPropertyTable objects may each be associated with different override tables in objects, or the ClassPropertyTable objects may share a single override table. In some embodiments this could be implemented by having the keys of this table encapsulate both the property name and the ClassPropertyTable object. In other embodiments, a two-level table structure can be used, with the keys of the override table being the ClassPropertyTable objects and the values being further tables mapping properties to overridden values. Other modes of implementation, including those which allow groups of objects to share overriding values, will be readily apparent.

The annotations table 420 of the Category object 416 contains three annotations, according to the example of FIG. 8. The annotations include values associated with the “count” annotation, “last update” annotation, and “accuracy” annotation. Note that annotations in the example of FIG. 8 differ from annotations in the examples of FIGS. 3-7. In FIGS. 3-7, the annotations are specified in the explicit table (202 in FIG. 3). However, in the FIG. 8 example, annotations are specified in the Category object 416—the explicit table 408 in this example assigns persistence values to annotations for indicating whether the annotations of the Category object 416 containing the annotations are to be persistent or transient.

In one example implementation, the interface AnnotatableObject is defined according to the Java code:

```
interface AnnotatableObject {
  Object getAnnotation(String key);
  void setAnnotation(String key, Object value);
  boolean isPersistentAnnotationKey(String key);
}
```

Three software methods are defined for the AnnotatableObject interface: getAnnotations(String key) (for retrieving a value of an annotation from the annotations table 420); a setAnnotation(String key, Object value) (for setting a value for a particular key); and isPersistentAnnotationKey(String key) (to determine if a particular annotation containing the specified key is to be persistent or not).

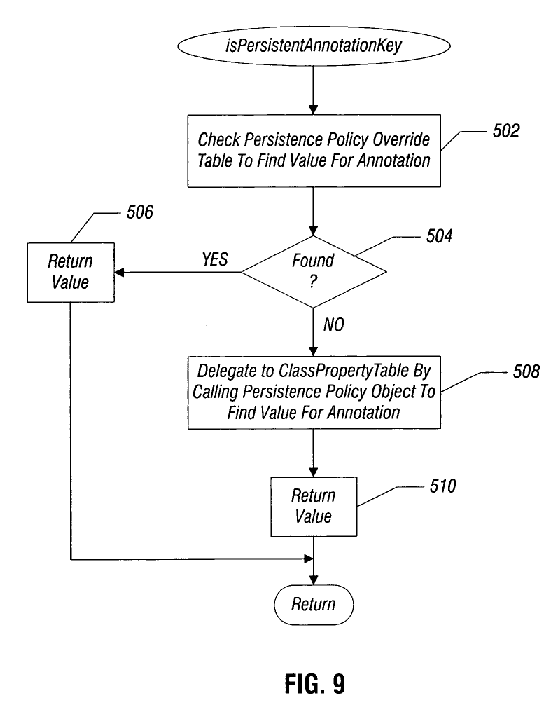

The logic of the isPersistentAnnotationKey( ) software method is depicted in FIG. 9. The isPersistentAnnotationKey( ) software method is called to determine whether a particular annotation (named by a specified key, “key”) is to be considered to be persistent. The isPersistentAnnotationKey( ) software method first checks (at 502) the persistence policy override table 418, if one has been created for the object, in the AnnotatableObject object (e.g., Category object 416) to find the persistence value for the specified annotation. If an entry for the specified annotation is found in the persistence policy override table 418 (as determined as 504), then the value from the persistence policy override table 418 is returned (at 506). Note that since the value for the specified annotation is found in the persistence policy override table 418, the isPersistentAnnotationKey( ) software method determines that it does not have to send a request to retrieve a value from the persistence policy object 406.

However, if the persistence policy override table 418 of the AnnotatableObject object (e.g., Category object 416) does not contain an entry for the specified key, then the isPersistentAnnotationKey( ) method delegates (at 508) to ClassPropertyTable by calling the persistence policy object 406 to find a value for the specified annotation. The value for the specified annotation can be found either in the cache table 410 or the explicit table 408 of the persistence policy object 406, and that value is returned (at 510).

In an example implementation, the persistence policy object 406 of FIG. 8 can be implemented as a BooleanClassPropertyTable class rather than a ClassPropertyTable class. The BooleanClassPropertyTable class is simply a wrapper around ClassPropertyTable. One example definition of BooleanClassPropertyTable is provided below:

```
class BooleanClassPropertyTable {
  final String YES = “yes”;
  final String NO = “no”;
  final ClassPropertyTable prop = new ClassPropertyTable( );
  void set(Class c, String key, boolean val) {
    prop.put(c, property, val ? YES: NO);
  }
  void forget(Class c, String property) {
    prop.forget(c, key);
  }
  boolean check(Class c, String property) {
    return prop.get(c, key) == YES;
  }
}
```

In the code above, the string YES is defined to be the value “yes,” and the string NO is defined to be the value “no.” The “yes” or “no” values are used to indicate whether a given property is to have a true or false value. In the context of the example of FIG. 8, this will be an indication that a specific annotation is to be considered to be persistent or non-persistent (transient). The prop.put( ), prop.forget( ), and prop.get( ) routines in the above code are the put( ), forget( ), and get( ) routines discussed further above. In the example definition of BooleanClassPropertyTable, the delegation is performed by means of explicit delegation to a ClassPropertyTable object referred to by the BooleanClassPropertyTable object. In an alternative embodiment, the BooleanClassPropertyTable class may rather inherit from the ClassPropertyTable class, if the language being used allows it, without exposing the ClassPropertyTable interface to its users, and simply delegate to itself using routines defined by the ClassPropertyTable class. In the example embodiment given above, a “true” value is returned from the check( ) routine only in the case in which the ClassPropertyTable object returns the YES value. The other two possibilities—a value of NO and a null value, representing no value stored—will result in a “false” value being returned. In alternative embodiments, the check( ) method can be defined so as to return “true” if the ClassPropertyTable does not contain a value for the key (making this the default). The check( ) method can return a default value specified when the BooleanClassPropertyTable object was created, or the check( ) method can use some other technique to establish the correct default value for a particular key.

In this manner, a flexible mechanism is provided to enable selection of whether an annotation is to be persistent or transient. Whether a particular annotation is to be persistent or transient can be defined with respect to an entire class and such specification can be used as an overridable default for subclasses of the class. Persistence indications can further be specified for specific instances of the class such that these more specific persistence indications override the persistence indication provided in the explicit table for the entire class. An interface (the AnnotatableObject interface) is provided to the user for convenient setting and retrieval of persistence values for various annotations. Consequently, traditional software code does not have to be added to support setting persistence values for annotations.

As noted above, in other embodiments, similar techniques are applied to enable other forms of processing of annotations, including whether an annotation should be displayed, whether an annotation should be communicated as part of the object when the object is communicated from one software process to another, or whether a value assigned in an annotation should be used in computing an aggregate.

Instructions of the various software modules (e.g., software 102 and various software methods) described above are loaded for execution on corresponding processors (e.g., CPUs 104 of FIG. 1). The processors include microprocessors, microcontrollers, processor modules or subsystems (including one or more microprocessors or microcontrollers), or other control or computing devices. As used here, a “controller” refers to hardware, software, or a combination thereof. A “controller” can refer to a single component or to plural components (whether software or hardware).

Data and instructions (of the software) are stored in respective storage devices, which are implemented as one or more machine-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). The storage media include either removable media or fixed media.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
associating, in a data structure, components in a hierarchy with corresponding maps that associate values with respective properties; and
in response to a request to retrieve a value associated with a first property for a first component that is part of the hierarchy, accessing the data structure in an order defined by the hierarchy to retrieve the value associated with the first property.

2. The method of claim 1, wherein the properties comprise thresholds, and wherein the associating comprises associating components in the hierarchy with corresponding maps that associate values with respective thresholds.

3. The method of claim 1, wherein retrieving the value associated with the first property comprises identifying an ancestor component in a list of components that are ancestors of the first component in the hierarchy, wherein the data structure associates a map with the identified ancestor component and the associated map associates a value with the first property.

4. The method of claim 3, wherein identifying the ancestor component in the list comprises identifying a first ancestor component in the list.

5. The method of claim 3, wherein ancestors of the first component include the first component and other components at higher levels in the hierarchy, the method further comprising storing the list.

6. The method of claim 5, further comprising sorting the list according to an order in which a first ancestor component in the list that is an ancestor of a second ancestor component in the list does not precede the second ancestor component in the list.

7. The method of claim 5, further comprising identifying a set of parents of a second component that is an ancestor of the first component to build up the list.

8. The method of claim 1, wherein the data structure comprises a first table, the method further comprising:
storing a cache table that associates properties with corresponding maps, each map of the cache table associating components of the hierarchy with values; and
modifying an entry in a corresponding map of the cache table in response to an access of the first table.

9. The method of claim 8, wherein modifying the entry comprises associating with a component an indication that no value is associated with the corresponding property.

10. The method of claim 8, further comprising removing a map from the cache table in response to a modification of a value associated with a corresponding property in the first table.

11. The method of claim 1, wherein the hierarchy of components comprises a hierarchy of classes, and wherein the request to retrieve a value associated with the first property comprises a first request, the method further comprising:
in response to a second request prior to the first request to retrieve a value associated with the first property for a given object, issuing the first request to retrieve the value associated with the first property for a class of the given object.

12. The method of claim 11, further comprising determining based on the value associated with the first property for the given object whether to process a data item of the object associated with the first property.

13. The method of claim 12, wherein the data item comprises an annotation and processing the data item comprises one of storing the annotation in a file, storing the annotation in a database, communicating the annotation to a software program, displaying the annotation, and using a value assigned in the annotation in computing an aggregate.

14. The method of claim 12, wherein determining whether to process the data item comprises comparing a value of the data item with the retrieved value

15. The method of claim 1, wherein the request to retrieve a value associated with the first property comprises a first request, the method further comprising:
receiving a second request prior to the first request to retrieve a value associated with the first property for a given object;
checking a second data structure associated with the given object in response to the second request; and
determining not to issue the first request upon discovering that the second data structure contains a value associated with the first property.

16. The method of claim 1, wherein the hierarchy of components comprises a hierarchy of classes, the method further comprising:
issuing the request to retrieve a value associated with the first property for a first class in response to a prior request to retrieve a value associated with the first property for a given object that is an instance of the first class,
wherein retrieving the value associated with the first property comprises inferring the value associated with the first property for the first class based on association of a value with the first property for a second class that is an ancestor of the first class.

17. The method of claim 1, wherein associating the hierarchy of components with maps comprises associating a hierarchy of classes with maps.

18. The method of claim 1, further comprising modifying a map associated with the first component in the hierarchy in response to a request to associate a second value with a second property for the first component.

19. The method of claim 1, further comprising creating a map to be part of the data structure and associating the created map with a second component.

20. The method of claim 1, further comprising modifying a map associated with the first component in response to a request to remove a value associated with a second property for the first component.

21. The method of claim 1, wherein retrieving the value comprises retrieving an indication that no value is associated with the first property for the first component.

22. The method of claim 1, further comprising returning a null value when the retrieved value is a distinguished mask value.

23. The method of claim 22, further comprising associating a second property with the distinguished mask value in a map associated with a second component in the hierarchy in response to a request to associate a null value with the second property for the second component.

24. The method of claim 1, further comprising storing the data structure as part of a policy object, the policy object associated with a first software routine to update the data structure and a second software routine to access the data structure.

25. The method of claim 1, wherein the first property is an object associated with the data structure, the method further comprising issuing the request in response to receipt by the first property of a second request to retrieve a value for the first property associated with one of the first component and an object associated with the first component.

26. A method comprising:
storing a policy object associating classes with maps, the maps indicating whether annotations are subject to predetermined processing, the classes being part of a hierarchy; and
in response to a request to determine whether a first annotation associated with a first class in the hierarchy is subject to the predetermined processing, accessing the policy object in an order reflecting the hierarchy to determine whether the first annotation is subject to the predetermined processing.

27. The method of claim 26, wherein storing the policy object associating classes with maps comprises storing the policy object associating classes with maps indicating whether annotations are to be persistently stored.

28. The method of claim 26, wherein storing the policy object associating classes with maps comprises storing the policy object associating classes with maps indicating at least one of: whether annotations are to be displayed; whether annotations are to be communicated to one or more software programs; and whether values assigned in annotations are to be used in computing aggregates.

29. The method of claim 26, wherein storing the policy object comprises storing a policy object containing a first table and a cache table, the first table containing information associating classes with maps, and the cache table storing information based on the information in the first table to enable faster access of information of the policy object.

30. The method of claim 26, further comprising storing an override table to override assignments of values made by maps of the policy object.

31. The method of claim 30, further comprising:
in response to the request, first accessing the override table to determine whether the first annotation is subject to the predetermined processing,
wherein accessing the policy object is in response to determining that the override table does not contain an indication of whether the first annotation is subject to the predetermined processing.

32. The method of claim 31, wherein storing the override table comprises storing the override table as part of an object, the method further comprising:
storing a second table as part of the object, the second table containing assignment of information to the first annotation and one or more other annotations.

33. Instructions on a computer-usable medium that when executed cause a system to:
associate, in a data structure, components in a hierarchy with corresponding maps that associate values with respective properties; and
in response to a request to retrieve a value associated with a first property for a first component that is part of the hierarchy, access the data structure in an order defined by the hierarchy to retrieve the value associated with the first property.

34. The instructions of claim 33, wherein the data structure comprises a first table, the instructions when executed causing the system to further:
store a cache table that associates properties with corresponding maps, each map of the cache table associating components of the hierarchy with values; and
modify an entry in a corresponding map of the cache table in response to an access of the first table.

35. The instructions of claim 33, wherein associating the hierarchy of components with maps comprises associating a hierarchy of classes with maps.

36. A system comprising:
means for storing a policy object associating classes with maps, the maps indicating whether annotations are subject to predetermined processing, the classes being part of a hierarchy; and
means for accessing the policy object in an order reflecting the hierarchy to determine whether a first annotation is subject to the predetermined processing, in response to a request to determine whether the first annotation associated with a first class in the hierarchy is subject to the predetermined processing.

37. The system of claim 36, wherein the predetermined processing comprises at least one of: persistently storing annotations; displaying annotations; communicating annotations to one or more software programs; and using values assigned in annotations in computing aggregates.

38. A system comprising:
a storage to store a policy object containing a first table and a cache table, the first table associating classes in a hierarchy with corresponding maps that associate values with respective properties, the policy object further containing a cache table that associates properties with corresponding maps, each map of the cache table associating classes of the hierarchy with values; and
a controller to:
in response to a request to retrieve a value associated with a first property for an instance of a first class that is part of the hierarchy,
access the cache table to determine whether the cache table contains an entry associated with the first class for the first property;
in response to determining that the cache table contains an entry associated with the first class for the first property, returning the value for the first property from the cache table;
in response to determining that the cache table does not contain an entry associated with the first class for the first property, access the first table in an order defined by the hierarchy to retrieve the value associated with the first property; and
add an entry for the first property in the cache table in response to the access of the first table to retrieve the value associated with the first property.
